(19) United States
(12) Patent Application Publication
(10) Pub. No.: US 2015/0006249 A1
(43) Pub. Date: Jan. 1, 2015

(54) COMPUTERIZED METHOD AND SYSTEM FOR PROCESSING DATA RELATED TO ESTABLISHMENT OF ENERGY SOURCES

(71) Applicant: Thomas Thaddeus Marshall, Minneola, FL (US)

(72) Inventor: Thomas Thaddeus Marshall, Minneola, FL (US)

(21) Appl. No.: 14/166,624

(22) Filed: Jan. 28, 2014

Related U.S. Application Data
(60) Provisional application No. 61/757,462, filed on Jan. 28, 2013.

(51) Int. Cl. G06Q 30/02; G06Q 50/06

(52) U.S. Cl. CPC G06Q 30/0205; G06Q 50/06
USPC 705/7.31

(57) ABSTRACT

A computer system for processing data relating to establishment of energy supply sources includes data storage devices storing data for potential customers of an energy supply source and one or more potential providers of an energy supply source, and one or more computer processors configured to access the data indicative of the one or more potential customers of an energy supply source; determine, based on the data indicative of the potential customers of an energy supply source, whether a trigger condition for establishment of an energy supply source by the one or more potential providers has been met; and, responsive to determining that the trigger condition has been met, provide an outgoing communication via a computer network to systems of the customers and the one or more potential providers that the trigger condition has been met.

### CROSS-REFERENCE TO RELATED APPLICATIONS

This application claims benefit of and priority to U.S. Provisional Patent Application Ser. No. 61/757,462, filed Jan. 28, 2013, the entirety of which is incorporated herein by reference for all purposes.

### FIELD OF THE INVENTION

This invention is in the field of alternative energy infrastructure and the operation of related alternative energy powered vehicles and/or equipment.

### BACKGROUND

The markets for certain types of alternative energy related products and services, including, but not limited to, for example, the market for Compressed Natural Gas (‘CNG”) refueling facilities and CNG powered vehicles and/or CNG powered equipment, electric vehicle charging stations or electric vehicle battery exchange facilities and electric vehicle conversion systems and electric vehicles as well as others are viewed by many to offer great potential for significant expansion and growth, particularly within the United States and in other countries. Alternative energy products refer to sources of energy for motor vehicles other than gasoline and diesel fuel, and include compressed natural gas, hydrogen, hydrogen-to-electric and electric batteries, by way of non-limiting example.

Certain examples exist in which operators of government agencies or facilities, including operators of vehicle fleets such as transit agencies and select private sector companies have committed to purchase and implement one or more CNG refueling facilities to support the operation of the vehicles under their management or control, such as, for example, CNG powered transit buses in certain communities. However, such examples are extremely limited. In fact, such efforts do nothing to address the unmet needs of the vast majority of potential operators of alternative energy infrastructure equipment such as, for example, CNG refueling facilities, who have largely refrained from purchasing or implementing and operating CNG refueling facilities due to a lack of minimally sufficient demand for CNG among individuals and companies that operate motor vehicles and/or equipment that, for the most part, do not presently depend upon CNG to operate within or in proximity to defined geographic areas. As a result, until now, it has been difficult, if not impossible, for most potential operators of CNG refueling facilities to justify incurring the costs associated with purchasing or implementing and operating CNG refueling facilities.

Alternatively, until now, potential operators of CNG powered vehicles and/or CNG powered equipment have similarly refrained from purchasing or implementing and operating CNG powered vehicles and/or CNG powered equipment or converting existing gas or diesel powered vehicles and/or equipment to be able to operate using CNG due to the lack of a minimally adequate CNG refueling facility infrastructure within or in proximity to those geographic areas where such CNG powered vehicles and/or CNG powered equipment would otherwise be operated by for the lack of available CNG. This dynamic has created what has been referred to by some as a classic “chicken and egg” scenario. It is this dynamic that has restrained and continues to restrain the growth of the CNG market as well as the growth of other alternative energy related markets that are affected by similar dynamics, including, for example, the market for electric vehicle charging facilities and/or electric vehicle battery exchange facilities, electric vehicle conversion systems and electric vehicles, among others.

Stated another way, potential operators of alternative energy dispensing equipment such as, for example, CNG refueling facilities (or e.g. electric vehicle charging facilities or electric vehicle battery exchange facilities, etc.) will only be reasonably likely to commit the necessary money, efforts and resources needed to purchase or implement and operate CNG refueling facilities within defined geographic areas when they are reasonably assured that a minimum number of CNG customers will exist to generate sufficient demand for CNG to support the operation of the CNG refueling facilities or that sufficient demand for CNG will likely exist within a reasonable timeframe after they initiate the operation of the CNG refueling facilities at selected locations within defined geographic areas.

Alternatively, potential operators of CNG powered vehicles and/or CNG powered equipment who may eventually desire to purchase CNG from CNG refueling facilities within or in proximity to defined geographic areas are only likely to commit to purchase or implement and operate CNG powered vehicles and/or CNG powered equipment when they are reasonably certain that one or more CNG refueling facilities will exist within or in proximity to the defined geographic areas where those CNG powered vehicles and/or CNG powered equipment will be placed into use since CNG is obviously necessary to operate CNG powered vehicles and/or CNG powered equipment. All of these same problems and dynamic that exist in the context of the CNG market that have inhibited the purchase or implementation and operation of CNG refueling facilities and the purchase or implementation and operation of CNG powered vehicles and/or CNG powered equipment also exist in regard to the market for other forms of alternative energy that necessarily depend upon such alternative energy infrastructure equipment and/or alternative energy related support services to operate other forms of alternative energy powered vehicles and equipment, including, but not limited to, for example, electric vehicle charging facilities or electric vehicle battery exchange facilities and electric vehicle conversion systems and electric vehicles within defined geographic areas. In the context of the electric vehicle market, in particular, examples have been well documented in the media and elsewhere in which electric vehicle charging stations were installed in locations within defined geographic areas in anticipation of the presumed rapid growth of electric vehicle usage only to go unused due to a virtually complete lack of electric vehicles being present and operated in the vicinity where the electric vehicle charging stations had been installed. In fact, in some cases, electric vehicle charging stations that had been installed within defined geographic areas were subsequently removed due to a lack of a minimally adequate number of electric vehicles and, thus, a lack of a minimum demand for electricity that was expected to be dispensed from the electric vehicle charging stations within or in proximity to those defined geographic areas. In the case of electric vehicle recharging stations and electric vehicles, in particular, problems associated with the length of time that it takes to recharge existing electric vehicle batteries has resulted in the development of certain other new business models, for example, wherein operators of electric vehicles would theoretically be able to drive into an electric vehicle battery exchange facility and have the battery in their electric vehicles removed and exchanged for a pre-charged electric vehicle battery within a presumably brief time frame. While such alternative business strategies and business models may seem able to address the immediate issues associated with the length of time that it may take to recharge batteries in electric vehicles so that the electric vehicles can effectively operate within defined geographic areas, neither electric vehicle recharging stations, nor electric vehicle battery exchange facilities or any other business models effectively address the underlying problems associated with the “chicken and egg” scenario described above relative to the purchase or implementation and operation of electric vehicle charging stations or electric vehicle battery exchange services complemented by the purchase or implementation and operation of electric vehicle conversion systems and electric vehicles within or in proximity to defined geographic areas in a way that efficiently coordinates supply and demand.

As a result of these problems in the context of the electric vehicle market, many potential operators of electric vehicle charging stations or electric vehicle battery exchange facilities have been and continue to be inhibited from incurring the costs associated with purchasing or implementing and operating electric vehicle charging stations and/or electric vehicle battery exchange facilities within defined geographic areas since each business model lacks the reasonable assurance or the ability to reasonably assure that a minimally adequate number of electric vehicles will be in operation within or in proximity to defined geographic areas where such electric vehicle recharging stations or electric vehicle battery exchange facilities operate so as to make such businesses sustainable once they are placed into service within defined geographic areas.

Alternatively, the purchase or implementation and operation of, for example, electric vehicle conversion systems and electric vehicles by individuals and companies that may otherwise desire to operate electric vehicles within defined geographic areas are similarly inhibited by a lack of a minimally adequate number of electric vehicle charging stations or electric vehicle battery exchange facilities within or in proximity to defined geographic areas necessary to support the operation of such electric vehicles once they are placed into service within defined geographic areas.

### SUMMARY

A need exists for a computer-based system and network wherein program participants, including suppliers of various types of alternative energy related products and services, including, for example, CNG refueling facilities, CNG powered vehicles and CNG powered equipment and other CNG related products and services can interact with other program participants, including existing and potential operators of such CNG refueling facilities, CNG powered vehicles, CNG powered equipment and other CNG related products and services for a variety of purposes including, but not limited to, the sharing of relevant and useful information, the coordination of sales of such various types of CNG equipment to and among program participants as well as to provide various forms of incentives for the benefit of program participants.

A need exists for a computer-based system and network wherein program participants including potential operators of alternative energy infrastructure equipment such as, for example, CNG refueling facilities, can review product information and interact with other program participants, including suppliers of CNG refueling facility equipment and interact with and possibly coordinate their purchase or implementation and operation of CNG refueling facilities within defined geographic areas with other program participants, including existing and/or potential operators of CNG powered vehicles and/or CNG powered equipment who may eventually purchase CNG from such CNG refueling facilities that may be established within or in proximity to defined geographic areas for the benefit of program participants.

A need exists for a computer-based system and network wherein program participants including existing operators of alternative energy infrastructure equipment such as, for example, CNG refueling facilities, can interact with interact with other program participants, including existing and/or potential operators of CNG powered vehicles and/or CNG powered equipment who may eventually purchase CNG from such CNG refueling facilities that may be expanded within or in proximity to defined geographic areas where demand for CNG may increase as a result of the purchase or implementation and operation of CNG powered vehicles and/or CNG powered equipment by other program participants for the benefit of program participants.

A need exists for a computer-based system and network wherein program participants including potential operators of alternative energy powered vehicles and/or equipment such as, for example, CNG powered vehicles and/or CNG powered equipment can review product information and interact with other program participants, including suppliers of such CNG powered vehicles and/or CNG powered equipment and possibly coordinate their purchase or implementation and operation of CNG powered vehicles and/or CNG powered equipment within or in proximity to defined geographic areas with other program participants, including existing and/or potential operators of CNG refueling facilities where CNG may be purchased once the CNG powered vehicles and/or CNG powered equipment is purchased or implemented and operated, as well as with other existing and potential operators of CNG powered vehicles and/or CNG powered equipment for the benefit of the program participants.

A need exists for a computer-based system and network wherein program participants including existing operators of alternative energy powered vehicles and/or equipment such as, for example, CNG powered vehicles and/or CNG powered equipment can interact with other program participants, including existing and potential operators of CNG refueling facilities where CNG may be purchased by the program participants as well as interact with other existing and/or potential operators of CNG powered vehicles and/or CNG powered equipment within or in proximity to defined geographic areas for the benefit of the program participants.

A need exists for a computer-based system and network wherein program participants including potential operators of various other forms of alternative energy infrastructure equipment and alternative energy powered vehicles and/or equipment such as, for example, electric vehicle recharging facilities and/or electric vehicle battery exchange facilities and electric vehicle conversion systems and/or electric vehicles can review product information and interact with suppliers of such electric vehicle recharging facilities or electric vehicle battery exchange facilities and electric vehicle conversion systems and electric vehicles as well as coordinate their purchase or implementation and operation of such electric vehicle related products and services within or in proximity to defined geographic areas for the benefit of the program participants.

In embodiments, a computer system for processing data relating to establishment of energy supply sources, includes: one or more data storage devices storing data indicative of a plurality of potential customers of an energy supply source of at least one type and one or more potential providers of an energy supply source of the at least one type; one or more computer processors configured to access the one or more data storage devices; and one or more memory devices storing computer-readable program instructions, which instructions, when executed by the one or more computer processors, cause the one or more computer processors to: access the data indicative of the plurality of potential customers of an energy supply source; determine, based on the data indicative of the plurality of potential customers of an energy supply source, whether a trigger condition for establishment of an energy supply source by the one or more potential providers has been met; and responsive to determining that the trigger condition has been met, provide an outgoing communication via a computer network to systems of the plurality of potential customers and systems of the one or more potential providers that the trigger condition has been met.

In embodiments, a computer implemented method for processing data relating to establishment of energy supply sources, includes: storing by one or more data storage devices data indicative of a plurality of potential customers of an energy supply source of at least one type and one or more potential providers of an energy supply source of the at least one type; accessing, by one or more computer processors, the data indicative of the plurality of potential customers of the energy supply source; determining, by the one or more computer processors, based on the data indicative of the plurality of potential customers of an energy supply source, whether a trigger condition for establishment of an energy supply source by the one or more potential providers has been met; and responsive to determining that the trigger condition has been met, providing by the one or more computer processors an outgoing communication via a computer network to the systems of the potential customers and systems of the one or more potential providers that the trigger condition has been met.

In embodiments, a non-transitory computer-readable storage medium having computer-readable program instructions stored thereon, which instructions, when executed by one or more processors, cause the one or more processors to: access data indicative of a plurality of potential customers of an energy supply source of at least one type and one or more potential providers of an energy supply source of the at least one type; determine, based on the data indicative of the plurality of potential customers of an energy supply source, whether a trigger condition for establishment of an energy supply source by the one or more potential providers has been met; and responsive to determining that the trigger condition has been met, provide an outgoing communication via a computer network to systems of the plurality of potential customers and systems of the one or more potential providers that the trigger condition has been met.

Embodiments of the present invention involve the purchase or implementation and operation of various types of alternative energy infrastructure related equipment or services by certain participants in a program, complemented by and coordinated with the purchase or implementation and operation of related alternative energy powered vehicles and/or equipment by certain other participants in a program within defined geographic areas, possibly within defined time frames, which activities are managed on one or more computers on a network for the benefit of the program participants.

In embodiments, this invention includes the purchase or implementation and operation of alternative energy infrastructure such as, for example, CNG refueling facility dispensing equipment (i.e. CNG refueling facilities) by certain participants in a program complemented by and coordinated with the purchase or implementation and operation of one or more CNG powered vehicles and/or CNG powered equipment by certain other participants in a program within defined geographic areas, possibly within defined time frames, which activities are managed on one or more computers on a network for the benefit of the program participants.

In embodiments, this invention also involves the purchase or implementation and operation of various other forms of alternative energy related infrastructure such as, for example, electric vehicle charging facility equipment or electric vehicle battery exchange facilities by certain participants in a program, complemented by and coordinated with the purchase or implementation and operation of electric vehicle conversion systems and electric vehicles by certain other participants in a program within defined geographic areas, possibly within defined time frames, for the benefit of program participants.

In embodiments, the methods and systems of the invention include a computer-based system and network wherein program participants are able to provide information that is inputted and stored by the program administrator and communicated, displayed and shared by various means with, by and among other program participants. The program may be free or may be fee-based, subscriber based, etc. The program participants may include various parties interested in or possibly affected or benefited by the sale and/or purchase or implementation and operation of various types of alternative energy infrastructure related products and services complemented by the sale and/or purchase or implementation and operation of certain other complementary alternative energy powered products and services, including, for example, a) suppliers/sellers of CNG products and services such as CNG refueling facility equipment, CNG powered vehicles, CNG engines, CNG conversion systems, CNG training programs, etc., b) potential buyers/operators of CNG refueling facilities, c) existing operators of CNG refueling facilities, d) potential buyers/operators of CNG powered vehicles or CNG powered equipment, e) existing operators of CNG powered vehicles or CNG powered equipment and f) other interested parties.

In embodiments, the methods and systems of the invention include of a computer-based system and network that enables program participants that may include one or more sellers/suppliers of CNG related products and services to register, provide relevant background information, provide product information, provide pricing information, etc. and interact and share information with other program participants. The program participants may also include individuals and companies that may be interested in purchasing or implementing and operating one or more CNG refueling facilities within or in proximity to defined geographic areas such as, for example, within one or more listed zip codes, counties, etc as well as individuals and companies that may be interested in purchasing or implementing and operating CNG powered vehicles and/or CNG powered equipment to register, provide relevant background information and interact and share information with suppliers of CNG powered vehicles and/or CNG powered equipment, review product information, etc. and also interact and share information with other program participants, including existing and/or potential operators of CNG refueling facilities within or in proximity to the defined geographic areas where such CNG powered vehicles or CNG powered equipment may be implemented and operated, possibly within defined time frames if when certain program parameters are met by other program participants including, for example, program participants that may purchase or implement and operate one or more CNG refueling facilities within defined geographic areas and possibly subject to other program parameters. Program participants, including existing and/or potential operators of CNG powered vehicles and/or CNG powered equipment may also interact and share information with other program participants including other existing and/or potential operators of CNG powered vehicles and/or CNG powered equipment within defined geographic areas for the benefit of program participants. In such cases, the program participants register, provide relevant background information, possibly interact with and share information with one or more suppliers of CNG refueling facility equipment, review product information, pricing information, product availability etc. and also interact with and share information with other program participants, including existing and/or potential operators of CNG refueling facilities as well as existing and/or potential operators of CNG powered vehicles and/or CNG powered equipment within or in proximity to the defined geographic areas where such CNG refueling facilities may be implemented and operated, possibly within defined time frames, if/when certain defined program parameters are met by other program participants. The types of program parameters that may be included and/or imposed by or upon participants in the program may vary depending upon the particular category of the particular program participant. For example, in the case of a potential operator of one or more CNG refueling facilities within a defined geographic area, in order for the program participant to proceed with the purchase or implementation and operation of one or more CNG refueling facilities within a defined geographic area, the program participant may require that a minimum number of other program participants including potential operators of CNG powered vehicles or equipment register on one or more lists of program participants within or in proximity to the defined geographic area where the CNG refueling facilities may be implemented and operated, possibly within defined time frames that may be established by program rules or by the program participants. A potential operator of one or more CNG refueling facilities may impose other conditions upon other program participants that may, for example, require a defined number of other program participants to demonstrate a good faith commitment to proceed with their purchase or implementation and operation of a defined number of CNG powered vehicles or to purchase a defined quantity of CNG powered equipment that will collectively generate a demand for a defined projected quantity of CNG within defined time frames that may be purchased from the CNG refueling facilities if/when the CNG refueling facilities are implemented and operated within a defined geographic area. The program participant may also indicate that if/when the demand for a defined minimum quantity of CNG that is projected to be needed by and among other program participants, including potential operators of CNG powered vehicles and/or CNG powered equipment who register on lists of program participants within defined geographic areas is reached, then the potential operator of the CNG refueling facilities will proceed with the purchase or implementation and operation of one or more CNG refueling facilities, possibly at pre-selected locations within a defined geographic area and possibly within a defined time frame thereafter or by other program parameters that may be established by the program participant or by a program administrator.

In embodiments, the methods and systems of the invention include a computer-based system and network that enables existing and potential operators of CNG powered vehicles and/or equipment to provide identifying information and to be placed on one or more lists of program participants which may possibly be displayed on a website or other communication media maintained within the computer-based system and network. The information provided by program participants may be fully or partially viewed or viewable by other program participants, including, for example, potential and/or existing operators of CNG refueling facilities so as to enable other such program participants to plan for the initiation of the coordinated purchase or implementation and operation of CNG refueling facilities within defined geographic areas, possibly within defined time frames that may coincide with the projected need for CNG to be purchased and consumed by existing or potential operators of CNG powered vehicles and/or equipment within or in proximity to defined geographic areas, possibly within defined time frames. The information provided by program participants may be fully or partially displayed on lists that may be viewed or viewable by other program participants including, for example, potential and/or existing operators of CNG powered vehicles or equipment so as to enable such other program participants to plan for the coordinated purchase or implementation and operation of CNG powered vehicles or equipment within defined geographic areas, possibly within defined time frames that may coincide with the availability of CNG from CNG refueling facilities that may be purchased or implemented and operated by other program participants within or in proximity to defined geographic areas.

In embodiments, the methods and systems of the invention also include a computer-based system and network wherein potential operators of electric vehicle recharging facilities, electric vehicle battery exchange facilities and other types of alternative energy infrastructure equipment and services can review information and interact with suppliers and complete purchases and/or otherwise plan to implement and operate such alternative energy infrastructure products and services within defined geographic areas and within defined time frames, possibly subject to certain conditions being met by other program participants such as the commitment by a prescribed minimum number of potential purchasers of electric vehicle conversion systems and/or electric vehicles to commit to purchase or implement and operate a minimum number of electric vehicles and commit to utilize the services of selected electric vehicle recharging facilities or electric vehicle battery exchange facilities that may be implemented and operated within defined geographic areas and to do so within defined time frames that may be established by the program participant, by other program participants or by program parameters for the benefit of program participants. The methods and systems of the invention include a computer-based system and network wherein a software program and algorithms may be employed to calculate the optimum locations for the implementation and operation of alternative energy infrastructure equipment such as, for example, CNG refueling facilities in order to support the operation of a maximum number of CNG powered vehicles and/or equipment that may exist within or in proximity to defined geographic areas. The optimum locations for the implementation and operation of CNG refueling facilities may be dynamically calculated and determined based, in whole or in part, upon the anticipated or projected demand for CNG by a calculated number of program participants, including program participants that may already operate CNG powered vehicles and/or CNG powered equipment as well as program participants that may plan to operate CNG powered vehicles and/or CNG powered equipment within or in proximity to defined geographic areas, possibly within defined time frames. The optimum locations for the implementation and operation of one or more CNG refueling facilities may also be dynamically calculated and determined by the software program based, in whole or in part, upon the anticipated or projected quantity of CNG that may be needed to support the operation of a smaller total number of CNG powered vehicles and/or CNG powered equipment that may nevertheless disproportionately consume greater quantities of CNG under the circumstances compared to other program participants so as to justify the implementation and operation of one or more CNG refueling facilities at a selected location that is in closest proximity to the program participants that are projected to consume the disproportionately greater amount of CNG even though a larger total number of program participants may exist within or in proximity to the defined geographic area where the CNG refueling facilities are to be implemented and operated.

In embodiments, the methods and systems of the invention provide that program participants may be offered and may receive a variety of incentives for meeting program parameters and/or disincentives or penalties for failing to meet program parameters. For example, in the case of a program participant that has committed to purchase or implement and operate a CNG refueling facility within a defined geographic area if/when a pre-determined minimum number of other program participants register and commit to purchase or implement and operate a defined number of CNG powered vehicles within the same geographic area and once that stated minimum number of other program participants is reached, then a discounted purchase price for the CNG refueling facility equipment may be offered if the program participant proceeds to purchase or implement and initiate the operation of the CNG refueling facility within a defined time frame thereafter. In another example, in the case of a program participant that has committed to purchase or implement and operate a defined number of CNG powered vehicles within or in proximity to a geographic area where a CNG refueling facility is in the process of being implemented and operated, program participants such as, for example, the operator of the CNG refueling facility may, either alone or in conjunction with other program participants, offer discounts or other incentives and benefits to the potential operator of the CNG powered vehicles in order for that program participant to initiate the use or operation of the CNG powered vehicles and become a customer of the CNG refueling facility, possibly within a defined time frame after the CNG refueling facility is implemented and in operation.

### BRIEF DESCRIPTION OF THE FIGURES

FIG. 1 is a schematic diagram illustrating a system according to an embodiment of the invention.

FIG. 2 is a process flow diagram illustrating a method according to an embodiment of the invention.

FIG. 3 is a process flow diagram illustrating a method of registering participants in connection with compressed natural gas facility facilities and CNG powered vehicles and/or equipment according to an embodiment of the invention.

FIGS. 4A-4C are a process flow diagram illustrating a method of administering a program for establishment of energy sources according to an embodiment of the invention.

FIG. 5 is a schematic diagram of a program administrator computer system according to an embodiment of the invention.

### DETAILED DESCRIPTION OF EMBODIMENTS OF THE INVENTION

Embodiments of the present invention include computer systems and methods for processing data relating to establishment of energy supply sources. Such energy supply sources may include alternative energy sources. Alternative energy sources may include a variety of facilities for replenishing energy supplies of vehicles and equipment that use alternative energy. Examples of such energy supply sources include CNG refueling facilities, electric vehicle charging facilities, and electric vehicle battery exchange facilities. Energy supply sources may also include facilities to support other types of alternative energy, including, by way of non-limiting example, hydrogen fuel for vehicles and equipment.

In embodiments, a computer system, such as a program administrator computer system, is configured to receive registrations of system participants. Participants may include, in embodiments, potential customers of an energy supply source of at least one type. Such potential customers may be individuals, families, businesses, government agencies, non-profit institutions and other enterprises that use vehicles and equipment, and are interested in converting some or all of those vehicles or equipment to operate using alternative energy of at least one type. The type of alternative energy may be compressed natural gas, electric batteries, or other types. The energy supply sources may be CNG refueling facilities, electric vehicle charging facilities, electric vehicle battery exchange facilities, and other energy supply sources, such as recharging facilities for hydrogen-powered vehicles, by way of non-limiting example. The participants may further include at least one potential provider of an energy supply source of the same at least one type; the at least one type may be CNG fuel or battery-stored electric; in embodiments, a potential provider may propose to provide energy supply sources of more than one type, such as both one or more CNG refueling facilities and one or more electric vehicle charging facilities, in the same geographic area, at the same or different locations. Such a provider may be a provider that is interested in establishing or expanding such an energy supply source, such as a CNG refueling facility, electric vehicle charging facility or electric vehicle battery exchange facility.

The potential provider may provide to a program administrator computer system profile information, including a provider identity, such as an entity name, a provider address, and a provider geographic area. The provider geographic area may be a geographic area selected by the provider for the energy supply source. The geographic area may be defined, in embodiments, in manners including a radius around a location, or a geographic area such as a county, city, township, borough, or one or more such political subdivisions. The provider may also provide one or more trigger conditions. The provider may agree, as part of the profile process, to open or expand the energy supply source, such as a CNG refueling facility, upon fulfillment of the trigger conditions. The trigger conditions may be for example, that potential customers, within the geographic area, register with the system and indicate or commit to purchase aggregate amounts of the energy supply, such as CNG.

The potential customers may similarly provide to the program computer system profile information, including a customer name, a customer location, such as an address, and energy supply usage commitment data. The energy supply usage commitment data may be in the form of numbers and types of vehicles to be converted to CNG or other alternative energy supply, and commitments as to intended amount of use, such as mileage on a daily, weekly or monthly basis. In embodiments, the energy supply usage data may take other forms, such as an amount or value of CNG or other energy supply to be purchased on a periodic basis.

The program computer system may require implementation steps to be committed to by the potential providers and by potential customers. Such steps may include providing proof of financial ability to carry out the implementation of an energy source or to convert vehicles to CNG or other energy source, provide down payments to providers of equipment and supplies, enter into an option to lease or purchase a property, or other steps. The program computer system may require implementation steps to be committed to by the potential provider and potential customers, subject to fulfillment of trigger conditions. Those implementation steps may include, for a potential provider, entering into a lease for property, ordering equipment, entering into installation contracts, and other tasks.

Upon registration of a provider and of potential customers, the program administrator computer system may create lists of providers and potential customers within the same geographic area.

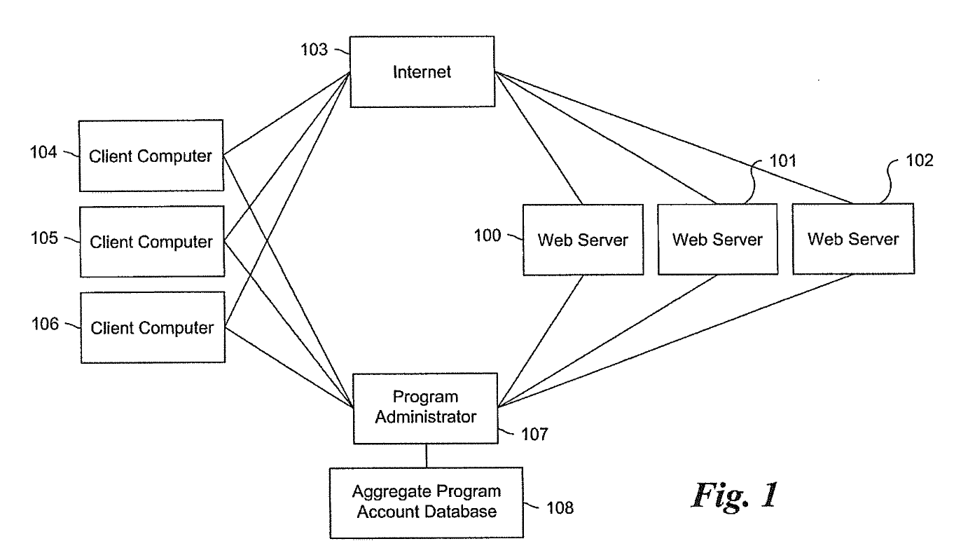

FIG. 1 is a schematic diagram illustrating a system according to the invention.

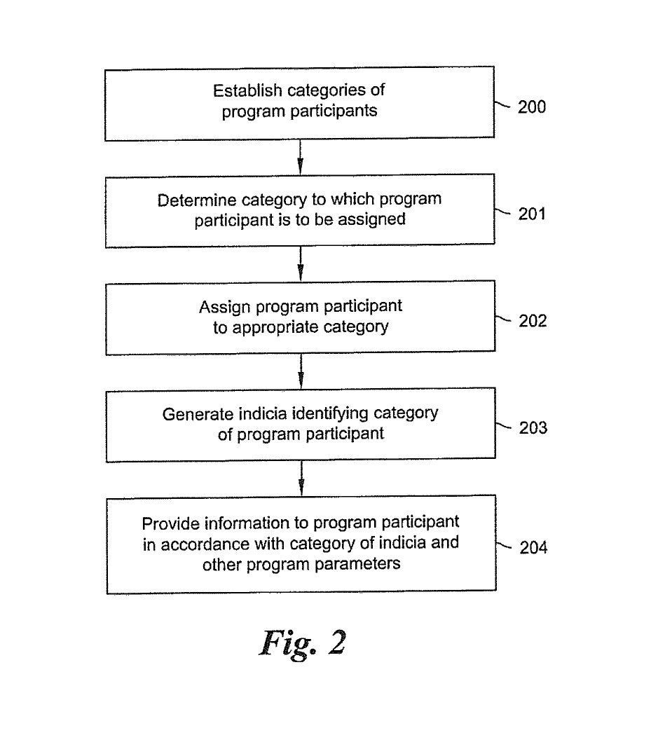

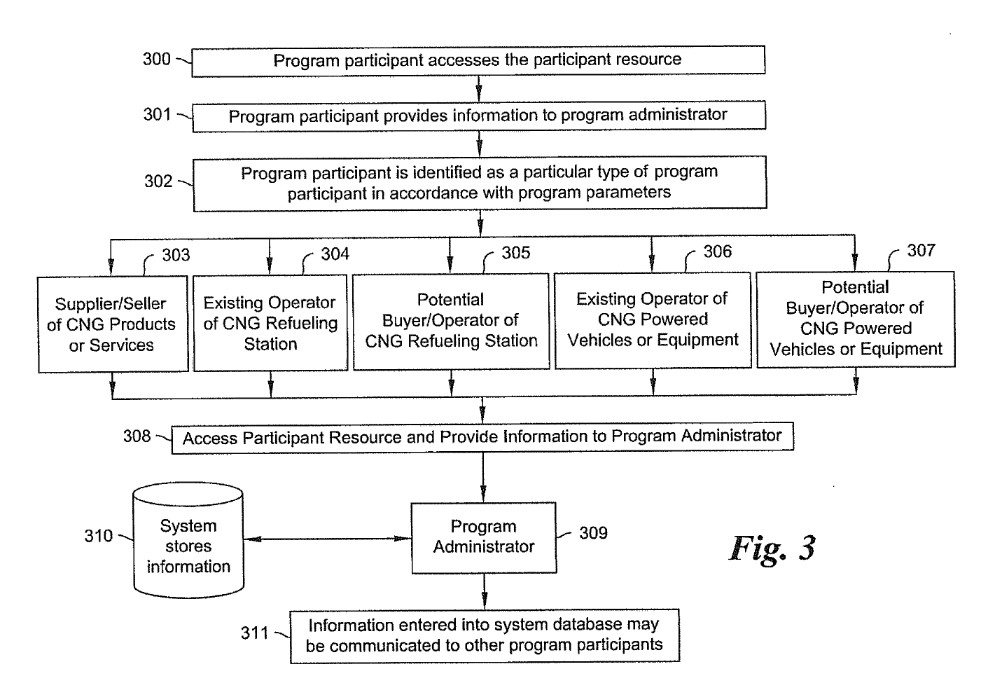

Referring to FIG. 1, there is shown a schematic diagram of a system in accordance with an embodiment of the invention, in its operating environment. A program administrator computer system 107 may perform data processing functions, including receiving user registrations, such as described in connection with FIGS. 2 and 3 below, creating lists of potential providers and potential customers in geographic areas, determining whether trigger conditions have been met, and providing notifications to participants. Program administrator computer system 107 may also arrange for sharing of information among participants, assessing and rating participants, and other functions described in this application. Program administrator computer system may take the form of a computer system storing computer programs in the form of processor-executable instructions for implementation of the methods and systems described herein. Program administrator computer system 107 may be implemented in embodiments as part of a cloud-based system. A cloud-based system includes any computer system that employs processor time, memory devices and other resources of third parties, such as resources located at one or more remote data processing centers or facilities.

Aggregate program account database 108 may include one or more data storage devices and systems, including systems local to the program administrator system, as well as remotely located systems and data storage devices, including cloud-based data storage. Aggregate program account database 108 may store data relating to participants, trigger conditions, implementation steps, and other data relating to program administration.

Web servers 100, 101 and 102 are connected to program administrator system 107, and provide generation and formatting of web pages for display on client computer systems 104, 105 and 106. Program administrator system 107 and aggregate program account database 108 may work together to generate data and instructions for web servers 100, 101 and 102 to generate suitable displays, such as in the form of HTML documents, for display on client devices, for participants to engage in registration with the program, including submission of profile data, review information regarding other participants in lists assigned by geographic areas, receive updates including data regarding fulfillment of trigger conditions, and other data. Web servers 100, 101, 102 are merely exemplary, and may include hardware systems running any suitable web server software, such as Apache HTTP Server, Apache Tomcat Server IIS (Internet Information Services), Nginx or Oracle Weblogic Server, by way of non-limiting example. The web servers 100, 101, 102 are connected through communications interfaces, which may be conventional interfaces, to a network 103, which may be or include the Internet, and then to client computer systems computer 104, 105 and 106, running suitable web browser software, such as Internet Explorer, Google Chrome or Mozilla Firefox. Client computer systems 104, 105 and 106 may include any type of computer system, including desktop computer systems, laptops, notebooks, tablets and smartphones. In embodiments, rather than web pages generated as HTML documents and processed by client-side browsers, the client computer systems may include one or more application programs, running on operating systems such as Windows 7, Windows 8, or on smartphone operating systems such as the Android and iOS operating systems, to exchange data with program administrator 107. In any suitable embodiment, the client computer systems exchange data with program administrator computer system 107 and the aggregate program account database 108 in order to implement methods and systems of the invention. For simplicity of presentation, other system components, such as local area networks and wireless networks, which may connect one or more indicated systems, and system components such as firewall devices, load balancing servers, and other devices, are not shown.

FIG. 2 is a process flow diagram of a high level process flow of a method relating to participants engaging in the program according to an embodiment of the invention and involving the participants of FIG. 1. The steps of FIG. 2 may be performed by program administrator computer system 107, such as by one or more computer processors of program administrator computer system 107 executing computer-readable program instructions stored in one or more memory deices of program administrator computer system 107. Referring now to FIGS. 1 and 2, participants in a method related to the establishment of a source of energy supplies will be discussed. The source of energy supplies may be, by way of example, a CNG refueling facility or an electric vehicle charging facility. The source of energy supplies may be a source of energy for motor vehicles. The source of energy may be a source of energy for motor vehicles appropriately equipped, licensed and registered to travel on public highways. Examples of such motor vehicles include CNG-powered vehicles and electric vehicles, which may include passenger cars, motorcycles, vans, buses, and trucks of a wide variety of sizes, weights, and specialized equipment and purposes. In embodiments, the motor vehicles may be or include motor vehicles not licensed or equipped for operation on public roads, such as certain all terrain vehicles, fork lifts, people movers and other types of motor vehicles for transporting people and goods. Examples of operators of equipment for transporting people and goods not on public roads may include operators of various types of contiguous campuses having numerous buildings. Non-limiting examples include educational institutions, including colleges and universities, office park operators and owners, retirement living facility operators, amusement park operators, shopping complex operators, and others. In embodiments, equipment for using the source of energy may be equipment other than motor vehicle equipment, such as small stationary machinery. In embodiments, the source of energy supplies may be complemented by and coordinated with the purchase or implementation and operation of alternative energy powered vehicles or equipment. For example, CNG powered vehicles or equipment are schematically illustrated, and a high-level process flow of a method related to program participants registering and providing and receiving information is illustrated.

Among the first steps indicated is a method to establish categories of program participants 200. Exemplary categories of program participants may include suppliers (or sellers) of CNG refueling facility equipment, suppliers of CNG powered vehicles or CNG powered equipment, potential buyers/operators of CNG refueling facilities, existing operators of CNG refueling facilities, potential buyers/operators of CNG powered vehicles or CNG powered equipment and existing operators of CNG powered vehicles and CNG powered equipment. In the context of an example of another form of alternative energy such as, for example, electric vehicles, the categories of program participants may include one or more of suppliers/sellers of electric vehicle recharging facilities or electric vehicle battery exchange facilities, suppliers/sellers of electric vehicle conversion systems and electric vehicles, potential buyers/operators of electric vehicle recharging facilities or electric vehicle battery exchange facilities, potential buyers of electric vehicle conversion systems and operators of electric vehicles, existing operators of electric vehicle charging facilities or electric vehicle battery exchange facilities and existing operators of electric vehicles. In a next step, a method to determine a category to which a program participant is to be assigned 201 is invoked. The process may involve generating a display screen, such as in an HTML document or on an application interface, to simply ask the participant to select one or more categories. In other embodiments, display screens may be generated to ask general questions of the participants, such as whether they wish to convert vehicles to be able to operate using CNG, or whether they wish to supply relevant products or services, and then assign the program participants based on the responses. One or more program participants are assigned to the categories 202. The system may then generate indicia identifying the category of program participant 203. Indicia may be displayed to the participant, by way of example. The system may then provide information to the program participant in accordance with category of indicia and other program parameters 204. The information may include information about the program, and requesting additional information from the participant.

FIG. 3 is a process flow diagram illustrating a system according to an embodiment of the invention. In an implementation, a program participant accesses a participant resource 300. The program participant provides background information to the program administrator 301, including, for example, name, address, the reason for interest in becoming a program participant etc. The program participant is identified as a particular type or category of program participant in accordance with program parameters 302 using the background information that is provided by the program participant. For example, in the context of the CNG market, such information may include whether the program participant is one of the following: a) a supplier seller of CNG products or services 303, including, but not limited to, CNG refueling facility equipment, CNG powered vehicles, CNG engines, CNG conversion systems, a CNG equipment finance provider. a CNG mechanic, a CNG maintenance or repair training program provider, etc.), b) an existing operator of CNG refueling facility(ies) 304, c) a potential buyer/operator of CNG refueling facility(ies) 305, d) an existing operator of CNG powered vehicles or equipment 306, e) a potential buyer/operator of CNG powered vehicles or equipment 307.

In connection with other forms of energy supply, including alternative energy supply, similar categories may be available. For example, in the context of the electric vehicle market, such information that may be provided by a program participant who accesses the program participant resource, provides information to the program administrator and is identified as a particular type of program participant in accordance with program parameters may include, for example, whether the program participant is one of the following: a) a supplier/seller of electric vehicle charging facilities or a supplier/seller of electric vehicle battery exchange facilities, b) a supplier of electric vehicle conversion systems, c) a supplier of electric vehicles, d) an existing operator of electric vehicle(s), e) a potential operator of electric vehicle(s) or, f) another type of electric vehicle related program participant.

The program participant accesses a participant resource and provides information to the program administrator 308. The program administrator 309 stores the information provided by the program participant 310, such as in a participant profile in an aggregate program account database 108 of FIG. 1. In any case, the type and variety of information requested by the system and provided to the program administrator by the program participant may depend upon the identification and categorization of the particular program participant in accordance with program parameters. For example, if the program participant is a supplier/seller of CNG products or services, the system may request, such as by display of one or more HTML documents including questions and drop down menus or blanks to be filled, a variety of information including, but not limited to, a description of the particular types of products or services offered by the supplier, product or service pricing information, information regarding discounts or other purchase incentives that may be offered to program participants, the geographic availability of the products or services offered by the program participant, if applicable, whether credit or financing is available to qualified potential purchasers of the products or services and other information. The system receives the information from a client computer system. Based on the received information, the program administrator establishes a program participant profile for the participant. The program participant profile includes participant data. In embodiments, the program administrator may verify or supplement participant data using third party sources of information, such as online business directories, commercial services such as the D&B service, and other resources.

The supplier/seller of CNG products or services may also be able to display information about their products or services within certain locations within a website operated by the program administrator. Such website locations may be made available to be viewed only by certain other program participants, such as by limiting access to participants providing credentials, such as user identifications and passwords. The program participants that are able to view such website locations may be limited based on data associated with program participants and algorithms to determine access, such as category, e.g., only pre-vetted potential buyers or operators may view web information relating to CNG products and services, and by geographic location. The system may pre-vet potential buyers or operators by requiring and receiving verification information, such as verification of financial ability to proceed, receipt of evidence of payments made to suppliers, and other evidence and documentation. Thus, only those participants determined, based on associated data and algorithms, to be interested in viewing and/or purchasing such products or services from the supplier/seller program participant, may view the products or services.

In embodiments, the program administrator may provide various levels of access and/or communications capabilities and preferences to the supplier/program participant as a condition to permitting the products or services offered by the supplier/seller program participant to be promoted to and viewed and/or made available or accessible in preferred ways to other program participants who may be interested in purchasing or implementing and operating such products or services. By way of non-limiting example, fees may be charged to supplier/seller program participants by the program administrator as conditions for making certain products or services accessible to certain categories or other customers. By way of further example, program participants who are likely to be interested in purchasing products or services may be offered discounts and/or other benefits for agreeing to be presented with information about available CNG products or services offered by other participants.

In an embodiment, an existing operator of one or more CNG refueling facilities within a defined geographic may provide information to the program administrator that may include, but may not be limited to: the present locations where the existing CNG refueling facilities are operated, hours of operation, discounts or other incentives that may be offered to new and/or existing customers; discounts or other incentives may be conditioned on such factors as purchases of defined, e.g., minimum, quantities or value of CNG, with conditions as to maximum time frames.

In an embodiment, a potential buyer/operator of one or more CNG refueling facilities may provide information to the program administrator that may include, but may not be limited to, the number of CNG facilities the potential buyer/operator program participant may desire to operate, the tentatively selected locations within or in proximity to defined geographic areas where the CNG refueling facilities may be implemented and operated, planned hours of operation, potential buyer/operator credit information, proof of funds and other capability sufficient for the potential buyer/operator to purchase or implement and operate a CNG refueling facility, minimum projected quantities of CNG that may be deemed minimally necessary by the potential buyer/operator of the CNG refueling facilities for other program participants to commit to purchase from the buyer/operator of the CNG refueling facilities (or that may be deemed necessary by the program administrator or by a supplier/seller of CNG facilities or a supplier of finance to purchase the CNG refueling facility equipment, etc., possibly within defined time frames, in order for the potential CNG refueling facility operator to commit to purchase or implement and operate the CNG refueling facility at a selected location. Time frames may be defined by suppliers, such as periods of 30 days, 60 days, 90 days, six months, or other periods, to meet one or more trigger conditions. In embodiments, such time frames may correspond to terms of option agreements to purchase or lease property for location of energy supply facilities, such as CNG refueling facilities.

As a demonstration of legitimate good faith commitment on the part of a program participant to proceed with the purchase or implementation and operation of one or more CNG refueling facilities within a defined geographic area, program parameters may require that such program participants take one or more of the following steps: pre-qualify for financing, pay an initial deposit toward the purchase of CNG refueling facilities or CNG powered vehicles and/or CNG powered equipment, enter into lease or purchase option agreements, or perform other program related tasks. The performance of such tasks may be shared with or reported to other program participants by various means. Scores and ratings may be generated by various means and based upon various criteria and assigned to program participants, which scores and ratings may be shared with other program participants based upon various criteria such as, for example, the performance of a program participant in successfully complying with program parameters or in failing to comply with program parameters, among others.

In an implementation of the invention, some or all of the information provided to the program administrator and entered into the system database may be communicated to other program participants 311. Subject to program parameters, program participant information communicated to the program administrator may be shared by various means with other program participants that may have an interest in or need for such information. For example, if a program participant that desires to purchase or implement and operate a CNG facility within a defined geographic area shares such information with the program administrator, this information may be communicated to other program participants located within or in proximity to the same defined geographic area where the program participant that provided the information to the program administrator is located. In this example, some of the information that the program participant may provide to the program administrator that may be communicated to other program participants may include, but may not be limited to, one or more trigger conditions necessary for the program participant to proceed with purchase or other implementation of the CNG fueling facility. The trigger conditions may include a time frame within which other conditions must be met, and a minimum defined projected quantity or value of CNG that will need to be purchased from the CNG refueling facility by participants within a given periodic time frame (e.g. daily, weekly, monthly). In embodiments, a trigger condition may be a minimum number of CNG powered vehicles that may need to be purchased or implemented and operated within or in proximity to the defined geographic area where the program participant is planning to implement and operate one or more CNG refueling facilities.

In the case of existing and/or potential operators of CNG powered vehicles within or in proximity to a defined geographic area, the type of information from the participant profile that may be communicated to other program participants may include, for example, vehicle characteristics (e.g., vehicle type such as passenger vehicle or truck, vehicle weight, and/or vehicle make and model), the estimated average total number of miles that such existing and potential operators of CNG powered vehicles are required to travel on a periodic basis (e.g., day, week, month, annual), and a geographic area within or in proximity to which the vehicles travel (e.g., a distance around an existing facility, throughout one or more geographic areas such as counties or cities, or a combination of those and/or other parameters). This information will provide an insight into the projected quantity of CNG that such program participants may consume over time, and the total defined scope of the geographic areas where such existing operators of CNG powered vehicles may be required to travel within defined time frames (which information will provide insight into the areas where CNG facilities may be optimally located in order to serve such program participants), the estimated total quantity of CNG that such operators of CNG powered vehicles may need to purchase within defined time frames in order to operate the CNG powered vehicles and/or other relevant data. The program administrator system may be configured to calculate amounts of CNG fuel or other alternative fuel to be used by program participants, based on such information as vehicle identification information, and to display this information to program participants.

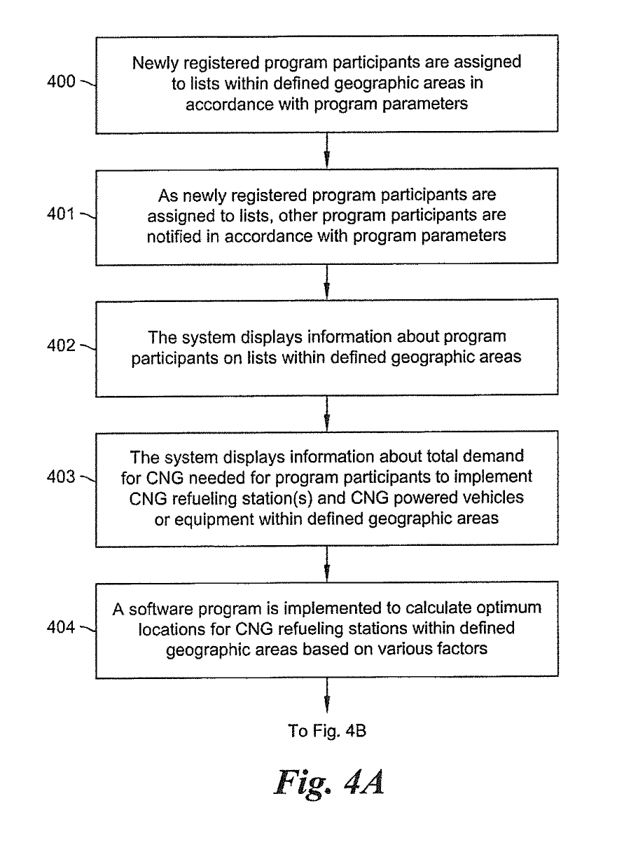

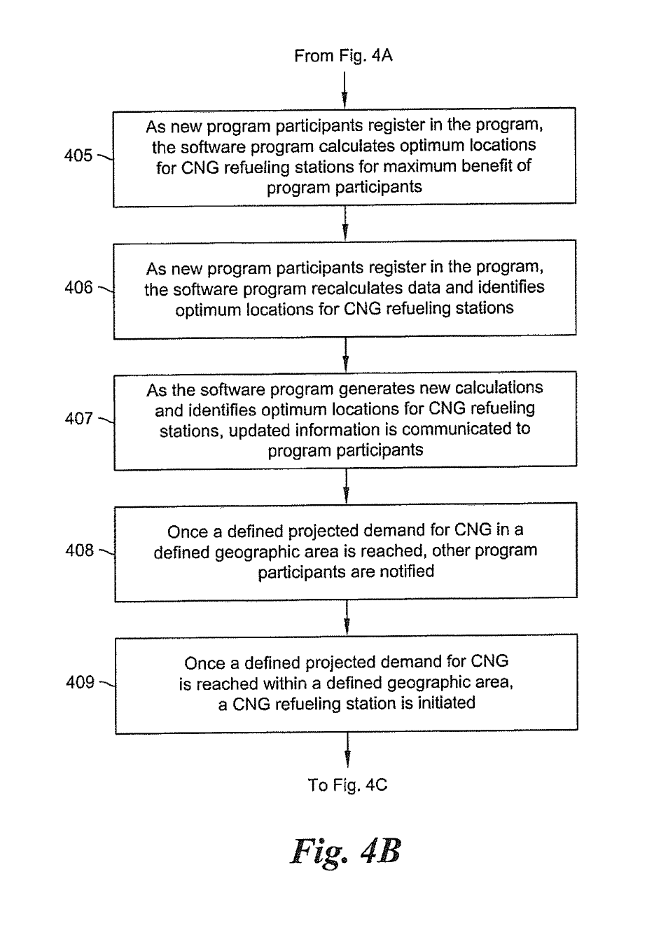

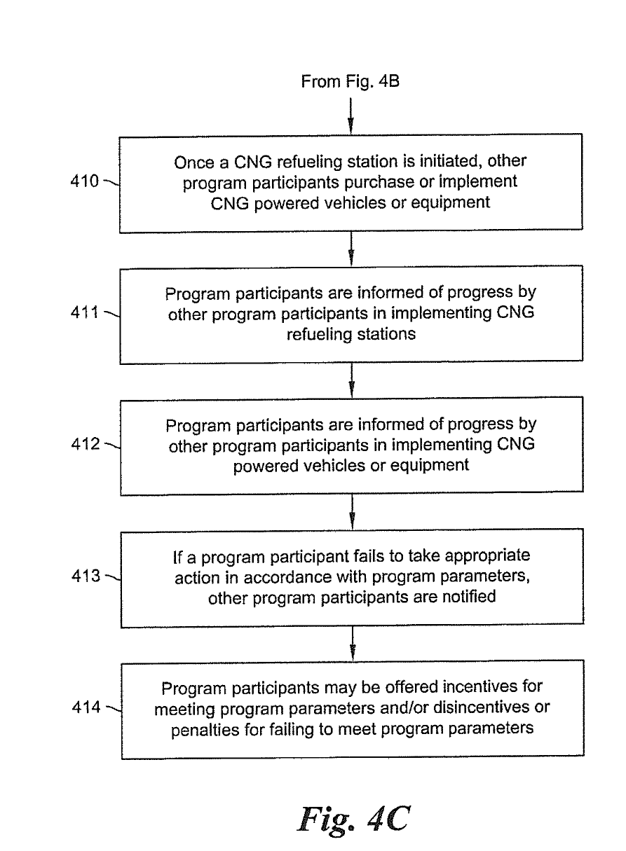

Referring to FIG. 4A, in an implementation of the invention, which may be implemented by program administrator computer system 107, newly registered program participants are assigned to lists within defined geographic areas in accordance with program parameters 400. As newly registered program participants are assigned to lists, other program participants may be notified in accordance with program parameters 401. The notification of other program participants may be provided by various means including, for example, email, text message, notifications on HTML documents presented to participants upon system log in, the posting of notifications on the lists displayed to other program participants, etc.

In an implementation of the invention, the system displays information about program participants on lists that are relevant to or within or in proximity to defined geographic areas 402. Separate lists may be provided in order to display program participants based upon the particular identification or categorization of the program participants with varying degrees of information disclosed based upon the particular identification or categorization of the program participants. The information that may be displayed regarding particular program participants may include some or all of the information that the program participant provided to the program administrator and to other program participants.

The program administrator system may determine scores and/or ratings for program participants at various times based upon their performance in complying with or failing to comply with program parameters, etc. By way of example, scores may be determined for compliance with requests for verification of financial or other capacity to purchase or implement CNG fueling facilities, purchase or retrofit and operate CNG powered vehicles, compliance with promised actions, such as establishing CNG fueling facilities and purchasing or retrofitting vehicles, based on other program participants meeting trigger conditions. These scores and/or ratings may also be displayed to other program participants. In general, higher scores may be associated with higher ratings. The scores or ratings may be numerical, letter grades, numbers of stars or numbers of other indicia, verbal ratings (bronze, silver, gold, e.g.) or other forms of ratings. The algorithms used to calculate these ratings may include generally a denominator including number of available goals that can be met, and a numerator based on goals actually met, which may be weighted by importance and by quality, for example.

The display and sharing of information related to program participants meeting certain criteria, e.g., being within defined geographic areas, and participating in the program with respect to a fuel type, will enable other program participants to benefit from the knowledge that program participants are committed to purchase or implement and operate CNG refueling facilities, CNG powered vehicles, CNG powered equipment, electric vehicle charging facilities or electric vehicle battery exchange facilities, electric vehicle conversion systems and/or electric vehicles, etc. For example, information provided by a potential operator of a CNG refueling facility will benefit by sharing information regarding where and when the CNG refueling facility may be placed into operation so that other program participants, including potential future customers of the CNG refueling facility within or in proximity to the same defined geographic area will be able to plan to purchase or implement and operate one or more CNG powered vehicles or CNG powered equipment within or in proximity to the defined geographic area where the CNG refueling facility will be located, possibly within defined time frames that may coincide with the initial implementation and operation of such CNG refueling facilities that are purchased or implemented and operated by other program participants. By displaying such information that is provided by program participants and making it accessible to, by and among other program participants, program participants can effectively coordinate the planning of the purchase or implementation, operation and/or expansion of CNG refueling facilities by existing or potential operators of CNG refueling facilities complemented by the purchase or implementation and operation of CNG powered vehicles and/or CNG powered equipment within or in proximity to the same defined geographic area for the benefit of the program participants.

In an implementation of the invention, the system displays information about trigger conditions, such as total periodic demand for CNG needed for program participants to implement, possibly within defined time frames, CNG refueling facilities, and CNG powered vehicles or equipment within defined geographic areas 403. For example, a potential operator of a CNG refueling facility registers in the program and is placed on a list within a defined geographic area. Information that the program participant provides to the program administrator that may be displayed or viewed by other program participants may include, for example, one or more trigger conditions. A trigger condition may be a projected demand for CNG among prospective customers of a CNG refueling facility within that defined geographic area that may be minimally needed in order for the potential operator of the CNG refueling facility to proceed with the purchase or implementation and operation of a CNG refueling facility. In the case of an operator of an existing CNG refueling facility, a trigger condition may be a projected demand for CNG among prospective customers that is sufficient for the operator to proceed with expansion of the existing capacity of the existing CNG refueling facility. Such an expansion may permit the facility to meet the projected increased demand among a growing CNG customer base and avoid undesirable shortages of CNG.

In embodiments, program participants (e.g. potential operators of CNG powered vehicles or equipment within or in proximity to the same defined geographic area where the CNG refueling facility may be operated) may also have their information displayed on a list that may be viewed and shared by and among other program participants, including other program participants who may be waiting to commit to purchase or implement and operate CNG powered vehicles or CNG powered equipment within or in proximity to the same defined geographic area where one or more CNG refueling facilities may be implemented and operated at some point. In this way, program participants will be able to observe that other similarly situated or similarly affected program participants are being added to the lists maintained within the same geographic area. Accordingly, participants may be able to estimate a time period by which trigger conditions have been met, such that other program participants (e.g. a potential operator of a CNG refueling facility) proceed to purchase or implement and operate one or more CNG refueling facilities within or in proximity to the defined geographic area where such program participants (i.e. potential operators of CNG powered vehicles or CNG powered equipment) may be located.

In an embodiment, the potential operator of a CNG refueling facility may indicate in its program participant profile that may be accessible and viewable by certain other program participants that, for example, a trigger condition has been set that once a projected minimum demand for a defined quantity of CNG exists among potential customers of a CNG refueling facility if and when it is purchased or implemented and placed into operation within the defined geographic area, the program participant (i.e. CNG refueling facility operator) will proceed to purchase or implement and operate one or more CNG refueling facilities within the defined geographic area. The profile may also include performance targets based on meeting the trigger condition. For example, the performance targets may include establishment of a CNG refueling facility, within a time period after the trigger conditions are met, the CNG refueling facility having parameters including capacity, regular operating hours/days, accepted forms of payment, geographic conditions (e.g., at a particular location, or within a defined geographic area), other services provided, such as conversion, maintenance and repair services for CNG powered vehicles and CNG systems, certification and/or training of staff to perform such conversion, maintenance and repair services, and other parameters. Meeting of such performance targets may be used in scoring the participant, as described elsewhere in this application. Program participants meeting certain criteria, such as geographic location criteria, will be given access to this information.

As a further example, a potential CNG refueling facility operator declares in its program participant profile that the operator will proceed with the purchase or implementation and operation of a CNG refueling facility within a defined geographic area, or at a specific location within the defined geographic area, e.g. within four weeks after trigger conditions have been met. The trigger conditions, in this example, require either one hundred other program participants, identified in their profiles as potential operators of at least one CNG powered vehicle within or in proximity to the same geographic area, within 6 months. Alternatively, the trigger condition may be the commitment of users to engage in at least 5000 miles of driving of CNG powered vehicles on a weekly basis. Alternatively, the trigger condition may be a commitment of program participants to purchase or consume at least a certain minimum defined volume of CNG. New program participants register and are identified as meeting the criteria as to ownership/operation of vehicles and geographic area. The system provides access to lists of program participants maintained within a given geographic area, so that all approved program participants can view some or all of the profile data about each other participant in the geographic area. The profile data may include name, whether the program participant is an individual or a business, business type, address, and any applicable trigger conditions. In embodiments, for participants who are intended buyers/operators of CNG powered vehicles, the users may be requested to provide an intended use, in addition to or instead of trigger conditions. For example, the intended use may be a certain number of CNG powered vehicles, of a certain type, driven a certain average distance on a weekly basis, or other uses, such as a mix of different types (passenger cars, trucks within certain weight ranges, by way of example), and different time periods (e.g., monthly or daily), by way of non-limiting example. A trigger condition and associated performance may be the existence of at least one CNG refueling facility in a given geographic area, with the performance being one vehicle retrofitted and converted to operate using CNG and driven a minimum distance. Thus, program participants planning to participate as vehicle operators may commit to steps, based on meeting trigger conditions, while reciprocal commitments are made by prospective refueling facility providers. Information regarding those new program participants and the nature and details associated with their commitments may be made available to other participants.

In embodiments, a trigger condition may be that participants may continue to register and place their names on those same lists, or be assigned by the system to lists, within or in proximity to the same defined geographic area at an average rate of ten new program participants per week, each of which indicate that they plan to purchase or implement and operate ten CNG powered vehicles, then the affected program participants can extrapolate from this information and anticipate that after approximately ten weeks, the goal of one hundred program participants including potential operators of CNG powered vehicles will be met at which point the potential operator of the CNG refueling facility will proceed with the purchase or implementation and operation of the CNG refueling facility within the defined geographic area, thus making CNG available for purchase on a timely basis by and among operators of CNG powered vehicles or equipment within or in proximity to the same defined geographic area. Thus, the trigger condition may be velocity of new commitments, such as by committed program participant CNG consumption per week, rather than a set periodic committed usage level. In the alternative, instead of a defined number of CNG powered vehicles, the target goal set by the potential operator of the CNG refueling facility (or set by the program administrator or by the CNG refueling facility equipment finance provider, etc.) may instead include a defined minimum quantity of CNG that is projected to be consumed per day, per week, etc. by program participants who plan to operate CNG powered vehicles and/or CNG powered equipment within or in proximity to the defined geographic area.

In an implementation of the invention, a system calculates optimum locations for CNG refueling facilities within defined geographic areas based on various factors 404. The factors may include locations of participants, routes or areas typically reached by vehicles of participants, numbers of vehicles at participant locations, and projected CNG consumption by participants. The system may implement one or more algorithms to determine minimum distance driven between participant locations and a CNG refueling facility. Such algorithms will generally provide for the location of the CNG refueling facility to be closer to locations of consumers of disproportionately larger quantities of CNG, due to number of vehicles, vehicle efficiency and projected mileage driven. As new program participants register in the program, the system recalculates optimum locations for CNG refueling facilities 405. For example, an operator of a business may be contemplating the purchase of a number of CNG powered vehicles but has refrained from doing so to date due to the lack of any CNG refueling facilities within or in proximity to the geographic areas where the business operator's CNG powered vehicles would need to be able to obtain CNG in order to efficiently operate on a daily or weekly basis may register as a program participant. In this case, the program participant may identify both a base location for the vehicles, such as a central office or warehouse, and identify geographic areas where the CNG powered vehicles will likely travel on a regular basis. For example, if the business has a warehouse at a suburban location, and need to be able to travel in a given day, week, etc. and, in turn, indicate where those CNG powered vehicles will need to be able to obtain access to CNG from a CNG refueling facility in order to enable the company to operate the CNG powered vehicles most efficiently in order to best serve the needs of the business. This information may be obtained directly from program participants. Alternatively, this information may be obtained from program participants through fleet or vehicle management software programs operated by the program participants, reflecting vehicle use prior to conversion, and sharing data with the program administrator, and by various other means. This information may be processed by the software program and an optimum location for the placement of CNG refueling facilities which, in turn, will result in the optimum location for the accessibility of CNG needed to operate the CNG powered vehicles (or the expansion of capacity of existing CNG refueling facilities) will be identified and communicated to program participants.

As new program participants register in the program, the software program recalculates the data and identifies optimum locations for CNG refueling facilities 406. For example, a number of program participants may have already registered as prospective operators of CNG powered vehicles and provided various information regarding their projected consumption of CNG once a CNG refueling facility is in operation within the defined geographic area. A newly registered program participant may provide information regarding its plans to purchase or implement and operate a relatively large number of CNG powered vehicles within the same geographic area. For example, previously registered program participants may have indicated plans to purchase or implement fifty CNG powered vehicles, each traveling an average of 20 miles per weekday. A new program participant may plan to operate three hundred CNG powered vehicles, each an average of 40 miles per day, within or in proximity to the same defined geographic area. In this example, it may be the case that the projected CNG consumption patterns of the three hundred CNG powered vehicles to be purchased or implemented and operated by the newly registered program participant are projected to be sufficiently large by themselves to warrant expanding the CNG refueling capacity of an existing CNG refueling facility or changing the tentatively selected location of a CNG refueling facility within the defined geographic area so that the CNG refueling facility is placed into operation at a different location that is calculated to be in closest proximity to the largest concentration of CNG powered vehicles that are to be operated by program participants within or in proximity to the originally defined geographic area in order to minimize the consumption of CNG during travel to and from the CNG refueling facility. In embodiments, the system may be configured to minimize the travel time to and from the CNG refueling facility, or to determine a minimum of a factor based partly on both consumption of CNG and travel time. As the system recalculates and identifies new optimum locations for CNG refueling facilities, updated information regarding the expansion of an existing CNG refueling facility capacity or the location of a proposed CNG refueling facility is communicated to program participants 407.

The system may employ routing systems and data to determine distance and travel time from various locations to various candidate CNG refueling facilities. For example, the system may be configured to determine an approximate CNG refueling facility location based on locations of vehicles. The system may weight customers that consume greater quantities of CNG more heavily, or not weight such vehicles based on consumption of greater quantities of CNG. The system may then select a number of candidate CNG refueling locations near the determined approximate location. The candidate locations may meet certain criteria, such as being zoned for filling facilities, being located along major highways or at intersections of major highways, and/or other criteria. Estimated totals of travel time and CNG consumption may be calculated between each of the candidate locations and the locations of the vehicles. The lowest total value of travel time, CNG consumption, a blended value based on both, and/or on additional factors, may then be determined as the new proposed CNG refueling facility location.

In the context of the electric vehicle market, the system may similarly calculate optimum locations for the implementation and operation of electric vehicle charging facilities or electric vehicle battery exchange facilities. The system may employ an algorithm for determining a location that minimizes travel time to and from the electric vehicle charging facility and/or electric vehicle battery exchange facility, the estimated quantity of battery charge to be consumed in traveling to and from an electric vehicle charging facility or electric vehicle battery exchange facility, or a blended factor based on both travel time and charge to be consumed, possibly combined with other factors in a manner similar to the methods described above in relation to CNG refueling facilities in order to further the goals of the program for the benefit of the program participants.

In embodiments in which a prospective operator is an institution that plans to convert or purchase vehicles solely for use on its property or campus, then the system may require the optimum location to be on the property or campus of the prospective operator.

In an implementation of the invention, once a trigger condition for a program participant who is a prospective provider of a CNG facility is achieved, the prospective provider, and the other program participants in the region are notified 408. The manner of notification may include any manner of notification, including e-mail, text notification, automated voice telephone call, a notification on a web page upon program participant representative log in, by way of example. The notification may include or be associated with a reminder to each program participant of their agreed performance requirement. For example, the system may retrieve, from the user profile of a program participant database, performance requirements as to time frame to opening, capacity, hours, staffing and any other requirements, and provide those performance requirements to the prospective provider participant. For prospective CNG facility operator participants, the system may retrieve from the user profile of a program participant database, performance requirements as to the number of CNG powered vehicles to be in operation and an agreed upon date.

Upon being notified that a trigger condition has been met, program participants may be required to respond to the program administrator or to other program participants and reconfirm their intention to proceed with the agreed performance requirements. Those performance requirements may include, by way of example, purchase or implementation and operation of one or more CNG refueling facilities, the purchase or implementation and operation of one or more CNG powered vehicles, one or more CNG engines, one or more CNG conversion systems or other CNG powered equipment or to take other steps in accordance with agreed upon performance requirements. In addition, program participants who have agreed to proceed with the purchase and implementation of CNG refueling facility equipment or operation of CNG powered vehicles or equipment may be notified that they must furnish evidence to the system within time intervals of steps taken to fulfill the agreed upon performance requirements. The steps may include, in the case of a program participant who has agreed to provide a CNG fueling facility, by way of example: placing orders with one or more vendors of CNG refueling facility equipment for the purchase of refueling facility equipment, and the installation of refueling facility equipment, entering into lease agreements for a property upon which the refueling facility will be placed, taking delivery of equipment, completing installation of equipment, making payment to vendors as required under agreements, and other steps. In the case of a participant who has agreed to convert one or more vehicles to operate using CNG or to purchase one or more CNG powered vehicles, the steps may include ordering equipment from a vendor of conversion equipment, entering into an agreement for CNG conversion services, ordering new CNG powered vehicles, taking delivery of CNG powered vehicles, completing installation of CNG conversion systems in vehicles, and other steps. Verification of steps may include receipt by the system of copies of confirmation documentation from vendors or program participants, receiving photographs of delivered and/or installed CNG equipment, receiving confirmation of payment, and other verification steps. In embodiments, the program administrator system may serve to transmit orders, order acknowledgements, payment confirmations, and other communications, in order to verify compliance and to otherwise further the goals of the program.

In an implementation of the invention, once a defined projected demand for CNG among existing and/or potential CNG powered vehicle owners/operators is reached within a defined geographic area, a CNG refueling facility is initiated 409. The purchase or implementation and operation of one or more CNG refueling facilities within a defined geographic area, possibly within a defined time frame, may be initiated in accordance with program parameters. For example, the initiation of the purchase or implementation and operation of one or more CNG refueling facilities by program participant may be subject to or contingent upon the coordinated purchase or implementation and operation of a minimum defined number of CNG powered vehicles or CNG powered equipment or the consumption of a minimum quantity of CNG by other program participants within or in proximity to the defined geographic area where the CNG refueling facilities will be implemented and operated in accordance with program parameters.

In an implementation of the invention, once a CNG refueling facility is initiated, other program participants purchase or implement CNG powered vehicles or CNG powered equipment 410. For example, program participants who are placed on lists within the same defined geographic area wherein the purchase or implementation and operation of one or more CNG refueling facilities has been initiated may be advised or directed to take appropriate steps to purchase or implement CNG powered vehicles or CNG powered equipment if they had previously expressed an intention to do so once the purchase or implementation and operation of one or more CNG refueling facilities was initiated within or in proximity to their defined geographic area, possibly within a defined time frame thereafter. To provide a more specific example, if a program participant had registered and expressed an intention to purchase five CNG conversion systems or five CNG engines that are to be installed in existing gas or diesel powered vehicles operated by the program participant, then the program participant may be directed to contact the supplier/seller of such CNG conversion systems or CNG engines and to otherwise proceed to complete those purchases and take other appropriate steps necessary to install the CNG conversion systems or CNG engines in those vehicles in accordance with program parameters. Of course, program participants may decide to proceed to purchase or implement such CNG refueling facilities, CNG conversion systems, CNG engines, etc. in advance of the projected target goals of the program being reached by program participants within or in proximity to a defined geographic yet remain in compliance with program parameters. In addition, partial achievement of steps such as the purchase or implementation of a partial quantity of CNG powered vehicles, CNG equipment, etc. may be determined to suffice in order for program participants to remain compliant with program parameters, depending on the particular circumstances and/or particular program rules.

In an implementation of the invention, program participants are informed of continuing progress by other program participants in implementing CNG refueling facility(ies) 411. As a potential operator of a CNG refueling facility within a defined geographic area proceeds to take concrete steps toward the purchase or implementation and operation of a CNG refueling facility within the defined geographic area, other program participants may receive notifications and other information as some or all of the various steps involved in the process of purchasing or implementing and operating the CNG refueling facility are completed. Examples of concrete steps that may be the subject of notifications provided to other program participants include, but may not be limited to, execution of a contract to purchase or lease land where the CNG refueling facility will be located, the purchase or lease of CNG refueling facility equipment from a supplier of such CNG refueling facility equipment that will be needed to operate the CNG refueling facility, execution of a contract with a contractor to construct the CNG refueling facility, and one or more steps toward the construction of the CNG refueling facility at a specific location within or in proximity to the defined geographic area. Any of these events may be communicated to other program participants, including, for example, program participants who are on lists maintained within the same defined geographic area who may be directly affected by such events and/or others.

In an implementation of the invention, program participants are informed of progress by other program participants in implementing the use or operation of CNG powered vehicles or CNG powered equipment 412. For example, if a program participant located within a defined geographic area where the purchase or implementation and operation of a CNG refueling facility has been initiated proceeds to place an order and/or pay for one or more CNG powered vehicles that may thereafter be delivered to the program participant within a defined time frame and otherwise in accordance with program parameters, then other program participants such as, for example, program participants located within or in proximity to that defined geographic area where the program participant is located may be informed of that event.

An example of other types of events that may be communicated to other program participants, including program participants located within or in proximity to the defined geographic area where the CNG refueling facility is in the process of being purchased or implemented and operated may include the successful lease or purchase of CNG powered vehicles, CNG conversion systems, CNG engines or other types of CNG equipment by a registered program participant in accordance with program parameters, the delivery of CNG engines to a program participant which CNG engines are to be installed in existing gas or diesel powered vehicles owned by the program participant, the successful installation of one or more of those CNG engines as the installations are completed, etc.

In an implementation of the invention, if a program participant fails to take appropriate action in a timely manner in accordance with program parameters, other program participants are notified 413. If a program participant who has previously agreed to establish or expand a CNG refueling facility has failed to take a particular action or implementation step by a required date, the notification is provided to program participants who are identified as operators of CNG powered vehicles and are within the geographic area that is to be served by the CNG refueling facility. Thus, the notified program participants are those program participants that may be adversely affected by the failure of the CNG refueling facility to become operational or expanded by the agreed upon time. Similarly, in the event of a failure of a program participant who has agreed to operate CNG powered vehicles to act in a timely manner in accordance with program parameters, such as by failing to place an order with a supplier of CNG conversion equipment within a certain time period after the notification, failing to purchase or order an agreed number of CNG powered vehicles within a stated time period after the notification, by way of example, both supplier participants and operator participants for the geographic area are notified. The failure of the operators to meet milestones to being ready to operate the agreed number of CNG powered vehicles may have a material impact upon the successful coordinated implementation of a CNG refueling facility system complemented by the purchase or implementation and operation of a minimally adequate number of CNG powered vehicles or equipment to consume a projected minimum quantity of CNG necessary to economically support the operation of the CNG refueling facility. For example, if a defined number of registered program participants commit to purchase or implement and operate a defined number of CNG powered vehicles or equipment within a defined time frame sufficient to meet program parameters, but the potential operator of a CNG refueling facility fails to initiate the purchase or implementation and operation of CNG refueling facility equipment within a defined time frame in order to meet established program parameters, the other affected program participants are notified of such a failure. In the event of such a failure, affected program participants may be notified and advised of alternative strategies to successfully initiate the implementation and operation of a CNG refueling facility within the defined geographic area, such as the initiation and operation of a different CNG refueling facility by one or more other potential operators of CNG refueling facilities, possibly at one or more other locations within the defined geographic area. In this example, program participants may, for example, delay their purchase or implementation of CNG powered vehicles or CNG powered equipment until such time as one or more CNG refueling facilities is initiated and successfully implemented and operated within or in proximity to their defined geographic area. The system may automatically recalculate due dates for operators of vehicles to engage in steps toward conversion of vehicles to operate using CNG, for example, in response to delays by a prospective CNG refueling facility owner. The participants may have the option of notifying the system of new due dates, as a result of delays in performance. Such new due dates may result in new, later due dates for other program participants, such as on a day by day basis, which new due dates may be communicated to the participants.

In an implementation of the invention, program participants may be offered incentives for meeting program parameters and/or disincentives or penalties for failing to meet program parameters 414. For example, parties that may individually or collectively offer such incentives to program participants may include the program administrator, suppliers/sellers of CNG refueling facility equipment, suppliers/sellers of CNG powered vehicles or CNG powered equipment, existing or potential operators of CNG refueling facilities within a defined geographic area, local state or federal governmental authorities or other parties that may have an interest in the expansion of the market for and use of CNG refueling facilities, CNG powered vehicles or CNG powered equipment within defined geographic areas). For example, in order to encourage registered program participants to comply with their good faith commitments to proceed with the purchase or implementation and operation of CNG powered vehicles or equipment within defined geographic areas, possibly within defined time frames, other program participants or other interested or affected parties may individually or collectively offer various incentives (e.g. individual or group discounts, rewards, tax deductions or credits, preferred access to CNG that may be available from another CNG refueling facility within defined geographic areas compared to other customers of the CNG refueling facilities who are not registered program participants if/when limited quantities of CNG may exist from time to time) so as to encourage program participants to more predictably and reliably purchase or implement and operate CNG powered vehicles or CNG powered equipment and/or to commit to purchase quantities of CNG from selected CNG refueling facilities within defined geographic areas, possibly within defined time frames. Alternatively, program participants who fail to meet program parameters may be penalized in various ways including, for example, loss of deposit monies that may be necessary to retain a position among program participants, such as, the operator of a CNG refueling facility to be initiated once defined program parameters are met by other program participants so as to ensure compliance with program parameters by program participants.

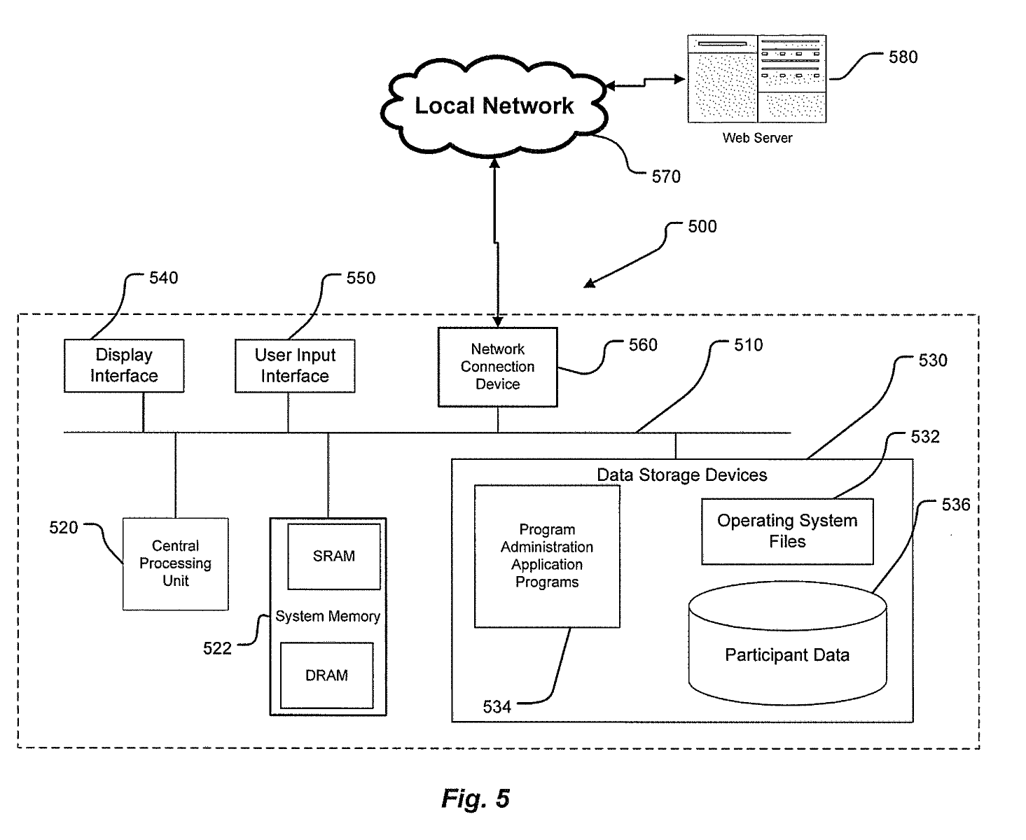

Referring to FIG. 5, an exemplary computer system according to an embodiment of the invention will be described. Computer system 500 may be an implementation of program administrator system 107 of FIG. 1, for example. Computer system 500 may include exemplary system bus 510, which may be exemplary of one or more system buses that provide bi-directional data communication among system components. Computer system 500 includes central processing unit 520, which may include one or more computer processors, including one or more microprocessors, co-processors and associated hardware. System 500 further includes system memory 522, which includes static random access memory and dynamic random access memory, accessed by processors of central processing unit 520. System 500 further includes one or more data storage devices or memory devices 530. Data storage devices 530 may include non-transitory data storage devices, such as magnetic hard drives, flash drives, optical storage and removable data storage devices such as DVD drives. Data storage devices 530 store data including operating system program files 532, which are accessed and executed by one or more processors of central processing unit 520. Data storage devices further store program administration application program files 534. Program administration application program files include computer-readable program instructions, stored on one or more non-transitory data storage media, which instructions, may be accessed by one or more processors of central processing unit 520, to carry out any of the steps of any embodiment of the invention described herein. Data storage devices 530 further include participant database 536, which includes participant data, such as participant name, address, category, trigger conditions, intended uses, score data, and other data related to implementation of any of the embodiments described herein. Participant database 536 is accessible by the one or more processors of central processing unit 520.

System 500 further includes display interface 540, which may include a video bus, video devices including memory and video processors, and video display devices. User input interface 550 may include interfaces for connection to user inputs such as touchscreens, keyboards and pointing devices such as mice. Network connection device 560 may provide connection for bi-directional data communication with local network 570, which in turn is in communication with web server 580. Web server 580 may be a hardware server system implementing web server software to generate HTML documents and receive data to implement any of the methods and systems described herein.

In embodiments, any of the methods and systems disclosed herein may be implemented using, and combined with, any of the methods and systems described in my U.S. Patent Application Publication No. 20030233278 and any of my prior applications referenced therein, which are expressly incorporated by reference herein. By way of non-limiting example, behavior and compliance of participants with the program may be incentivized by any of the methods and systems described in any of those applications.

The methods and systems of the invention may be accomplished using a wide variety of computer programs and systems and communications devices and media. The particular types of computer systems and software employed and communications devices and media may be readily selected by those of skill in the art.

Although exemplary embodiments are described in detail above, the invention is not limited thereto. Additional embodiments and variations within the scope and spirit of the invention will be appreciated by those of skill in the art.

What is claimed is:

1. A computer system for processing data relating to establishment of energy supply sources, comprising:
one or more data storage devices storing data indicative of a plurality of potential customers of an energy supply source of at least one type and one or more potential providers of an energy supply source of the at least one type;
one or more computer processors configured to access the one or more data storage devices; and
one or more memory devices storing computer-readable program instructions, which instructions, when executed by the one or more computer processors, cause the one or more computer processors to:
access the data indicative of the plurality of potential customers of an energy supply source;
determine, based on the data indicative of the plurality of potential customers of an energy supply source, whether a trigger condition for establishment of an energy supply source by the one or more potential providers has been met; and
responsive to determining that the trigger condition has been met, provide an outgoing communication via a computer network to systems of the plurality of potential customers and systems of the one or more potential providers that the trigger condition has been met.

2. The computer system of claim 1, wherein the energy supply source of at least one type is a compressed natural gas (CNG) refueling facility, and the plurality of potential customers comprise prospective operators of CNG powered vehicles.

3. The computer system of claim 2, wherein the data indicative of one or more providers of the CNG refueling facility comprises a provider identity, a provider address, and a provider geographic area, and the one or more trigger conditions, the one or more trigger conditions comprising data indicative of CNG consumption by a plurality of customers within the geographic area.

4. The computer system of claim 3, wherein the data indicative of a plurality of potential customers comprises, for each of the potential customers, a customer name, a customer location, a proposed number of CNG powered vehicles, and proposed CNG powered vehicle usage data.

5. The computer system of claim 4, wherein the computer-readable program instructions further cause the one or more processors, responsive to receiving data indicative of an additional one of the potential customers in the provider geographic area, determine whether the one or more trigger conditions have been met.

6. The computer system of claim 4, wherein the computer-readable program instructions further cause the one or more processors, responsive to receiving data indicative of an additional one of the potential customers in the provider geographic area, determine an optimum location for a CNG refueling facility in the provider geographic area.

7. The computer system of claim 6, wherein the computer-readable program instructions further cause the one or more processors to determine the optimum location for the CNG refueling facility by determining a location resulting in a minimum of consumption of CNG fuel in traveling between the locations of the potential customers in the provider geographic area and the location for the CNG refueling facility.

8. The computer system of claim 2, wherein the computer-readable program instructions further cause the one or more processors to determine whether the participants in the provider geographic area are meeting required implementation steps.

9. The computer system of claim 8, wherein the computer-readable program instructions further cause the one or more processors to cause the determination of whether the participants are meeting required implementation steps to be displayed to others of the participants in the provider geographic area.

10. A computer implemented method for processing data relating to establishment of energy supply sources, comprising:
storing by one or more data storage devices data indicative of a plurality of potential customers of an energy supply source of at least one type and one or more potential providers of an energy supply source of the at least one type;
accessing, by one or more computer processors, the data indicative of the plurality of potential customers of the energy supply source;
determining, by the one or more computer processors, based on the data indicative of the plurality of potential customers of an energy supply source, whether a trigger condition for establishment of an energy supply source by the one or more potential providers has been met; and
responsive to determining that the trigger condition has been met, providing by the one or more computer processors an outgoing communication via a computer network to systems of the potential customers and systems of the one or more potential providers that the trigger condition has been met.

11. The computer-implemented method of claim 10, wherein the energy supply source of at least one type is a compressed natural gas (CNG) refueling facility, and the plurality of potential customers comprise prospective operators of CNG powered vehicles.

12. The computer-implemented method of claim 11, wherein the data indicative of one or more providers of the CNG refueling facility comprises a provider identity, a provider address, and a provider geographic area, and the one or more trigger conditions, the one or more trigger conditions comprising data indicative of CNG consumption by a plurality of customers within the geographic area.

13. The computer-implemented method of claim 12, wherein the data indicative of a plurality of potential customers comprises, for each of the potential customers, a customer name, a customer location, a proposed number of CNG powered vehicles, and proposed CNG vehicle usage data.

14. The computer-implemented method of claim 13, further comprising, responsive to receiving data indicative of an additional one of the potential customers in the provider geographic area, determining whether the one or more trigger conditions have been met.

15. The computer-implemented method of claim 13, further comprising, responsive to receiving data indicative of an additional one of the potential customers in the provider geographic area, determining an optimum location for a CNG refueling facility in the provider geographic area.

16. The computer-implemented method of claim 15, further comprising determining the optimum location for the CNG refueling facility by determining a location that results in a minimum of use of CNG fuel in traveling between the locations of the potential customers in the provider geographic area and the location for the CNG refueling facility.

17. The computer-implemented method of claim 11, further comprising determining whether the participants in the provider geographic area are meeting required implementation steps.

18. The computer-implemented method of claim 17, further comprising causing the determination of whether the participants are meeting required implementation steps to be displayed to other program participants in the provider geographic area.

19. A non-transitory computer-readable storage medium having computer-readable program instructions stored thereon, which instructions, when executed by one or more processors, cause the one or more processors to:
access data indicative of a plurality of potential customers of an energy supply source of at least one type and one or more potential providers of an energy supply source of the at least one type;
determine, based on the data indicative of the plurality of potential customers of an energy supply source, whether a trigger condition for establishment of an energy supply source by the one or more potential providers has been met; and
responsive to determining that the trigger condition has been met, provide an outgoing communication via a computer network to systems of the plurality of potential customers and systems of the one or more potential providers that the trigger condition has been met.

20. The computer-readable medium of claim 19, wherein the computer-readable program instructions further cause the one or more processors, responsive to receiving data indicative of an additional one of the potential customers in a provider geographic area, determine whether the one or more trigger conditions have been met.
